(19) United States
(12) Patent Application Publication
(10) Pub. No.: US 2012/0036197 A1
(43) Pub. Date: Feb. 9, 2012

(54) Messaging Genealogy Interface

(75) Inventor: Michael L. Bishop, Atlanta, GA (US)

(73) Assignee: AT&T INTELLECTUAL PROPERTY I, L.P., Reno, NV (US)

(21) Appl. No.: 12/851,643

(22) Filed: Aug. 6, 2010

(51) Int. Cl. G06F 15/16

(52) U.S. Cl. 709/206

(57) ABSTRACT

A number of related electronic messages can be presented in an organized and intuitive manner by associating each of the messages with a message generation and displaying a set of message nodes, each associated with a particular message, organized by generation. The messages nodes are associated or linked with one another to indicate a portion of the respective message lineage. The messages displayed can be filtered so that the viewer of the interface is only presented with messages to which the viewer is a participant. The interface also displays a list of message thread participants over all related electronic messages or on a generation-by-generation basis. The list of participants can also categorize participants as active or passive.

### FIELD OF THE INVENTION

The present disclosure is generally directed to electronic messaging, and more particularly to an interface for mapping and displaying relationships and chronology of electronic messages.

### BACKGROUND

Electronic mail (i.e., e-mail) and other forms of electronic messaging have become a preferred mode of communication in many situations. The near-instantaneous nature of e-mail and the ease with which participants in the communication can be added to the message distribution list and/or contribute to the discussion are a few of its advantages. However, these beneficial features also contribute the problem of organization and tracking of messages within a conversation (e.g., message thread) as the number of participants increases and the linearity of the responses decreases. Typical electronic message programs organize messages in a lockstep, linear manner organized by time and date received. Navigating a message thread typically requires chronologically reviewing all the messages in the message thread often displaying unrelated or tangential messages in confusingly close proximity.

### SUMMARY

In accordance with one embodiment, a number of related messages can be presented by associating each of the messages with a message generation. A first set of message nodes associated with a first message generation are then displayed. A second set of message nodes associated with a second message generation are also displayed. The second generation is immediately subsequent to the first message generation, and each message node of the second set of message nodes is associated with a particular message node of the first set of message nodes so as to indicate at least a portion of a respective message lineage

In accordance with a further embodiment, a third set of message nodes associated with a third message generation immediately subsequent to the second message generation can be displayed. Each message node of the third set of message nodes is associated with a particular message node of the second set of message nodes so as to indicate at least a portion of a respective message lineage. The associations between the message nodes can be indicated within the interface.

In accordance with yet a further embodiment, the first set of message nodes and the second set of message nodes are associated with select ones of the plurality of related messages having a particular user as either a sender or a recipient. In this manner, only messages to which a particular participant is a party are displayed in the interface presented to the particular party.

The interface can further identify all participants in the plurality of related messages. The identification of participants can be done on a generation-by-generation basis or across the set of related messages. Additionally, the identification of participants can be divided into active and passive participants.

These and other advantages will be apparent to those of ordinary skill in the art by reference to the following detailed description and the accompanying drawings.

### BRIEF DESCRIPTION OF THE DRAWINGS

FIG. 1 is an exemplary messaging interface in accordance with an embodiment;

FIG. 2 is an exemplary messaging interface in accordance with a further embodiment;

FIG. 3 is an exemplary messaging interface in accordance with a further embodiment;

FIG. 4 is a flow diagram of a process for generating and displaying an interface in accordance with an embodiment; and

FIG. 5 is a high-level diagram of a computer in accordance with an embodiment.

### DETAILED DESCRIPTION

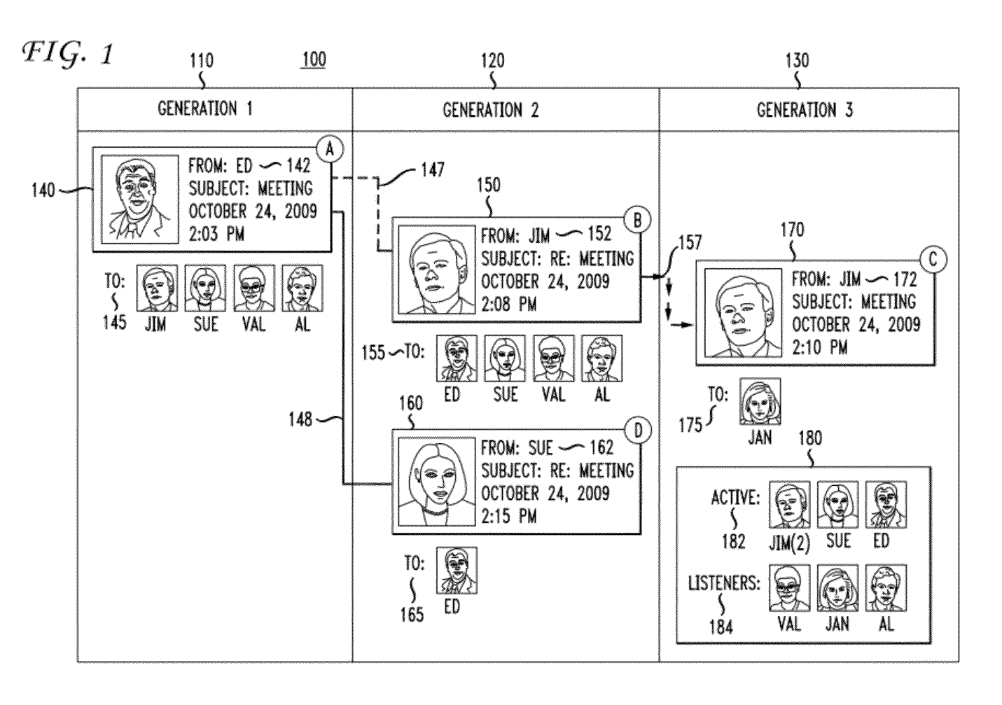

FIG. 1 is an exemplary display of an interface 100 in accordance with one embodiment. As illustrated, interface 100 illustrates a number of messages (e.g., an email message thread) organized in a manner to convey visually the history of each message, the parties involved in each message, and other meta-data concerning the messages. Specifically, the messages are analogized to a family tree presenting a genealogy of each message and are organized by generation such that each message is a node in the tree and any action stemming from that node (e.g., reply, reply to all, forward, etc.) creates a new node in the tree connected by a branch. In this manner, the lineage of any message in a message thread (i.e., the sequence of messages related a specific message) can be easily discerned from the interface 100.

Exemplary interface 100 includes the display of three generations: a first generation 110, a second generation 120, and a third generation 130. While interface 100 groups each generation in a vertical fashion and organizes the generations so that each subsequent or later generations is to the right of the previous generation (i.e., left to right), a person of ordinary skill in the art would understand that interface 100 could organize the generations from right to left or group each generation in a horizontal fashion such that each subsequent generation is above the previous generation (i.e., in a bottom to top fashion), below the previous generation (i.e., in a top to bottom fashion), or another orientation.

The first generation 110 includes a single message node 140, which is the first message chronologically in the message thread. Message node 140 can be a representation of a message and associated with that message in a user's messaging program (e.g., email program), or it can be a display of the associated message itself. Message node 140 includes certain header information 142, such as the sender, subject, and date sent. The header information 142 also includes a display of the recipients 145 of the message. Additional information such as the blind-carbon-copy recipients, an identification or link to any attachments to the message, and a priority of the message can also be included in the header information.

As recipients receive and/or read the message, information concerning the delivery-receipt or read-receipt can be displayed and associated with each party in the recipient list 145. The recipients that have read or received the message can also be differentiated using a graphical indicator such as a predetermined color to highlight the recipient's name or icon.

The second generation 120 includes two message nodes 150 and 160 each corresponding to a reply message to the first message of message node 140. Each message node displayed in the interface 100 can include header information and a recipient list. Thus, message node 150 includes header information 152 and a recipient list 155, and message node 160 similarly includes header information 162 and a recipient list 165.

The third generation includes a single message node 170, which is a forward of the message associated with message node 150. As discussed with respect to message nodes 140, 150, and 160, message node 170 can also include header information 172 and a recipient list 175.

Interface 100 includes a visual indication of the association between message nodes. Specifically, branch 147 indicates the connection between message node 140 and message nod 150, branch 148 indicates the connection between message node 140 and message node 160, and branch 157 indicates the connection between message node 150 and message node 170. The color or pattern of each branch can indicate the type of relationship between the nodes. For example, branch 147 is illustrated with a broken line to indicate that the message associated with message node 150 was a Reply-to-All (i.e., the message was sent to the sender of the preceding message and all recipients to which that message was sent). Branch 148 is illustrated with a solid line to indicate that the message associated with message node 160 is a reply only to the sender of the preceding message. Branch 157, which associates message node 170 and message node 150, is illustrated using arrows to indicate that the message associated with message node 150 was forwarded in a message associated with message node 170.

Interface 100 further includes a participant display 180. The participant display 180 is an identification of all the users that have received a message that is part of the message thread. The participant display can be divided into active participants 182 and listeners or passive participants 184. Active participants 182 indicates all parties that have created a message within the family tree, for example by sending the first message 140 or replying to or forwarding the first message 140 or a subsequent message. Passive participants 184 indicates the parties who are recipients of a message in the message thread but have not generated a message within the family tree.

The participant display 180 can be generated on a per-generation (i.e., generation-by-generation) basis or on a message thread basis. That is, as illustrated by interface 100, the participant display 180 can identify all active participants 182 and passive participants 184 for the entire message thread. Additionally, the participant display 180 can be generated for a specific generation such that only the parties that have sent or received a message associated with the specific generation are identified.

In accordance with one embodiment, the display of interface 100 is an administrative display of the message thread. That is, the interface 100 includes all messages that belong to the message thread, regardless of the recipient or sender. Thus, even if a particular user was not party to a message (i.e., neither sender nor receiver), if the particular user were an administrator or had administrative rights with respect to the message thread, interface 100 would display the message node associated with that message to the user. For example, Ed, who is the sender of the message of message node 140 is neither a sender nor a recipient of the message of message node 170. However, if Ed were an administrator, or had administrative rights, Ed would have access to message node 170 from interface 100.

Administrative rights can be assigned to specific users. Alternatively, the interface 100 can automatically assign administrative rights to the originator of the message thread, for example Ed as the sender of the original message of message node 140. In yet a further feature, administrative rights can be assigned with a much finer granularity. For example, the sender of each message associated a message node can be assigned administrative rights for all messages that descend from that message node.

Participants that do not have administrative rights can be restricted to view only message nodes to which they are participants. That is, the interface presented to a specific user can be limited to displaying only those message nodes for which the user is either a recipient or sender of the associated message.

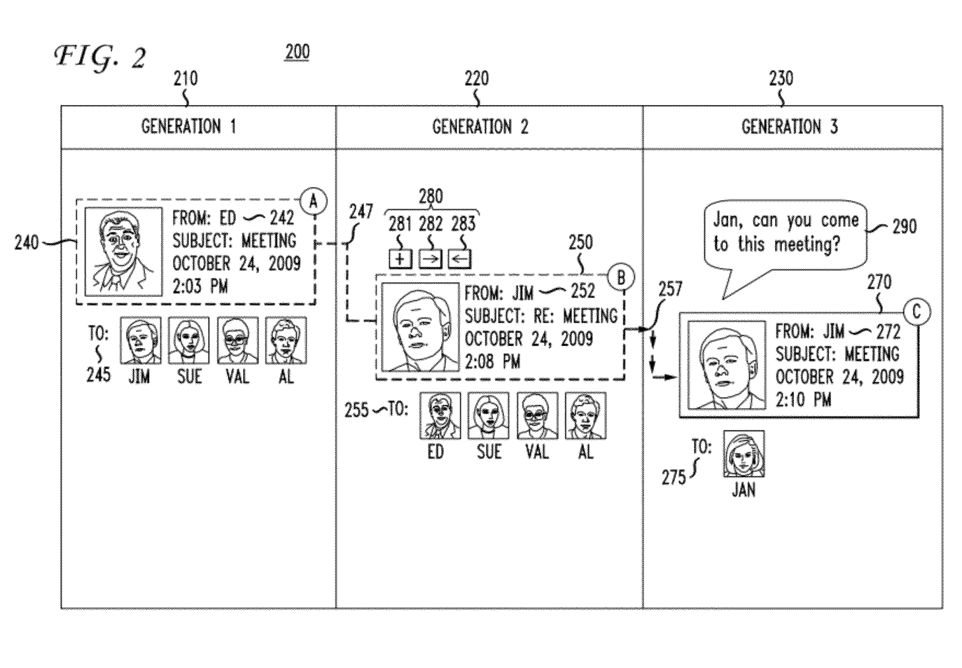

FIG. 2 illustrates an interface 200 that is representative of a display of the message thread discussed with respect to FIG. 1 as would be visible to Jim. As similarly discussed with respect to FIG. 1, interface 200 includes a first generation 210, a second generation 220, and a third generation 230. The first generation 210 includes a single message node 240, which includes header information 242 and recipient list 245. The first message node 240 is visible to Jim because Jim is a recipient of the message as indicated in the recipient list 245. The second generation 220 includes a display of message node 250, which includes header information 252 and recipient list 255. Message node 250 is connected to message node 240 by branch 247. Message node 250 is visible to Jim because Jim is the sender of the associated message. The third generation 230 includes a display of message node 270, which includes header information 272 and recipient list 275. Message node 270 is connected to message node 250 by branch 257. Message node 270 is visible to Jim because Jim is the sender of the associated message (i.e., Jim forwarded the message associated with message node 250 to Jan).

It is noted that message node 160 of FIG. 1 is not included in the second generation 220 displayed within interface 200. The message associated with message node 160 was sent by Sue to Ed. Jim is therefore not a party to this message and message node 160 is not included in interface 200.

In accordance with a further feature, a navigation bar 280 can be associated with one or more of the message nodes. Navigation bar 280 is associated with message node 250 and includes an “expand/collapse” navigation button 281, a “back” navigation button 282, and a “forward” navigation button 283. The expand collapse button 281 allows the user to expand or collapse the message tree from that node forward. For example, toggling navigation button 281 would cause all messages subsequent to and related to message node 250 (e.g., message 270) to disappear.

If the message tree is deep (i.e., includes many different generations) the back button 282 and forward button 283 can be used to navigate the display of the tree. The back button 282 enables a user to change the view of interface 200 by shifting the generations display backward. That is, by toggling the back button 282, a user can shift the generations to the right, thereby enabling the display of an earlier generation. The forward 283 enables a user to change the view of interface 200 by shifting the generations display forward. That is, by toggling the forward button 283, a user can shift the generations to the left, thereby enabling the display of a subsequent generation.

Because each message node is associated with a message in the message thread, additional information concerning each message can be displayed in the interface 200. For example, by selecting message node 270, the contents of the associated message can be displayed in a dialog box 290. Alternatively, selection of the message node 270 could launch the user's messaging program and load or display the associated message. Thus, in addition to navigating the chronology of a message thread, the contents of the message thread can be explored as well.

In accordance with yet a further feature, a user can search the message thread for messages matching user-defined criteria. These criteria can include a simple condition or a complex Boolean expression of multiple conditions. All message nodes associated with messages that satisfy the user-defined criteria can be indicated within the interface, for example by highlighting the message node. Interface 200 illustrates the results of a search for all messages to which Val was a party. As a result of such a search message nodes 240 and 250 are shown with a highlighted border. Optionally, the criteria that match the search can also be highlighted. For example, as illustrated in interface 200, because the search requested all messages to which Val was a party, the identification of Val in recipient lists 245 and 255 is highlighted.

The interface 200 can be user-interactive to assist in the construction of such a search. For example, if a user selects the icon or text associated with a particular participant in the message thread, the interface 200 can automatically highlight all message nodes that include that participant as the sender or a recipient.

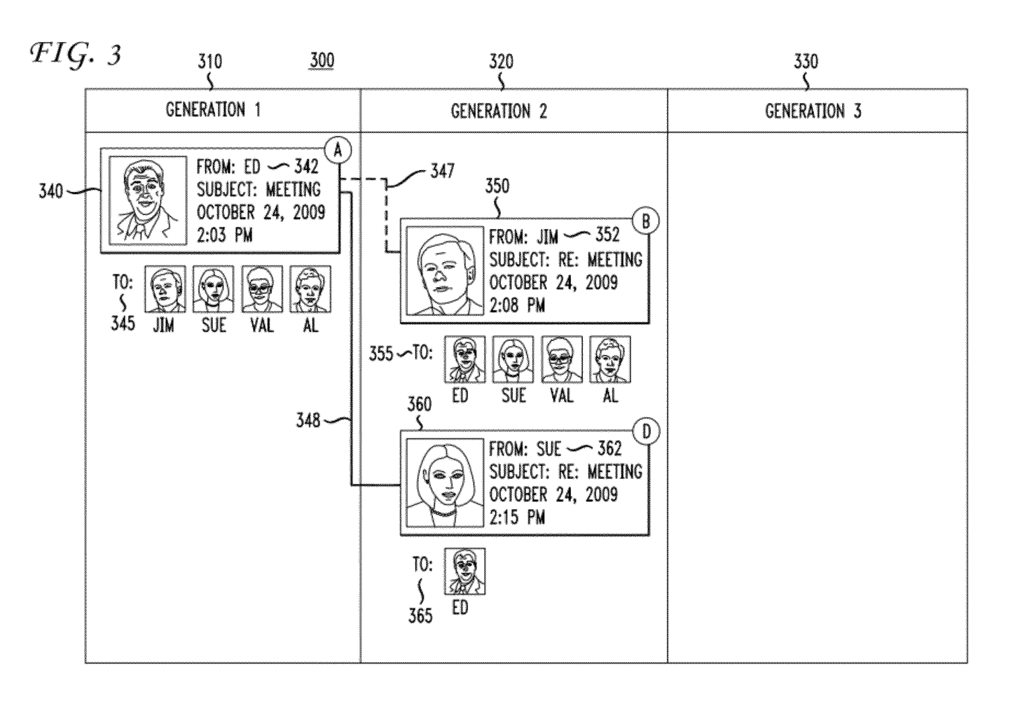

In a further example of the personalization of the interface, FIG. 3 illustrates an interface 300 that is representative of a display of the message thread, discussed with respect to FIG. 1, as it would be visible to Ed. As similarly discussed with respect to FIG. 1, interface 300 includes a first generation 310, a second generation 320, and a third generation 330. The first generation 310 includes a single message node 340, which includes header information 342 and recipient list 345. The first message node 340 is visible to Ed because Ed is the sender of the message as indicated in the header information 342. The second generation 320 includes a display of message nodes 350 and 360. Message nodes 350 and 360 respectively include header information 352 and 362 and recipient lists 355 and 365. Message node 350 is connected to message node 340 by branch 347. Message node 360 is connected to message node 340 by branch 348. Message node 350 is visible to Ed because Ed is a recipient of the message associated with message node 350. Similarly, message node 360 is visible to Ed because Ed is a recipient of the message associated with message node 360.

The third generation 330 is displayed as empty. It is noted that message node 170 of FIG. 1 is not included in the third generation 320 displayed within interface 300. The message associated with message node 170 was sent by Jim to Jan. Ed is therefore not a party to this message and message node 170 is not included in Ed's view of the message thread (i.e., interface 300).

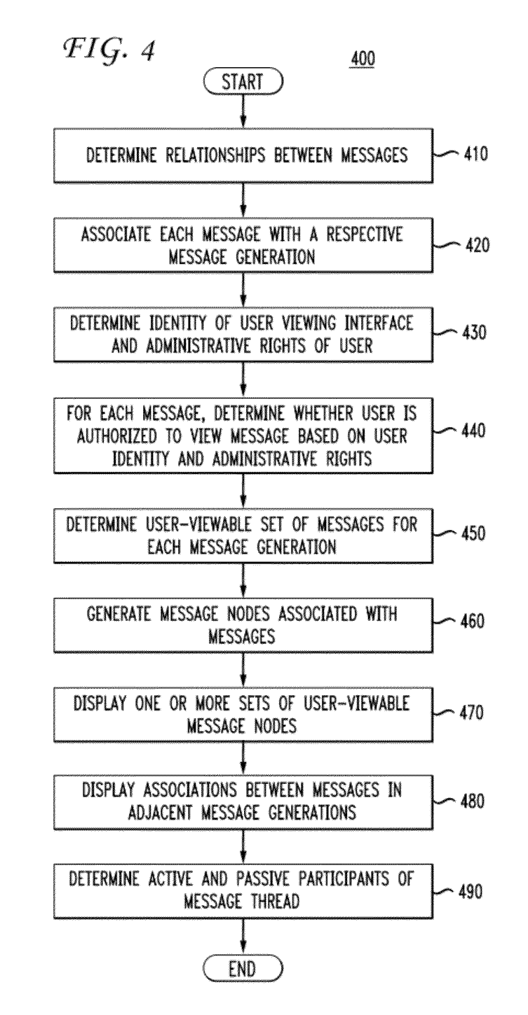

FIG. 4 is a flow diagram of a process 400 for generating an interface displaying a number of related messages, such as interface 100, 200, or 300 described above. In accordance with process 400, the relationships between messages are determined at step 410. For example, it can first be determined which messages are part of a common message thread. Then, the specific lineage of each message can be determined. If a second message is in reply to a first message or is a forward of the first message, the second message is considered related to the first message.

At step 420, each message is associated with a respective message generation. In accordance with one embodiment, an n-ary tree of the related messages can be created, and each generation determined based on a breadth-first search of the n-ary tree.

Each user viewing the interface may be authorized to view only certain messages within a message tree. In one embodiment, the message interface is generated locally based on the messages stored within the user's messaging client. Thus, only those messages to which the user is a sender or recipient will be included the generation of the interface. In accordance with a further embodiment, at step 430, the identity of the user viewing the interface is determined along with a determination of any administrative rights assigned to that user. Thus, at step 440, it is determined for each message in the message thread whether the user is authorized to view the message based on the user's identity and the user's administrative rights.

At step 450, user-viewable sets of messages are determined based on the user's identity and administrative rights determined at step 440. Each set of messages is associated with a particular message generation. At step 460, message nodes are generated for each message in the user-viewable sets of messages. As discussed above, each message node typically includes certain header information such as the sender, subject, timestamp, and recipient list. Additionally, each message node is associated with its respective original message such that additional information concerning the message can be retrieved or queried.

One or more of the sets of user-viewable message nodes are displayed at step 470, and at step 480, the association between messages in adjacent message generations are displayed. These associations can be displayed as branches between two messages indicating the subsequent message is a reply, forward, or other response to the earlier message.

At step 490, a list of active and passive participants in the message thread is determined. This list can be determined on a generational-basis or across the entirety of the message thread.

It should be noted that while process 400 is generally described with respect to processing a set of related messages as a group, the steps described can be performed incrementally as messages are received or sent. That is, process 400 can be used to generate an interface display for a pre-existing set messages or it can be used to update an interface display as messages are received or sent.

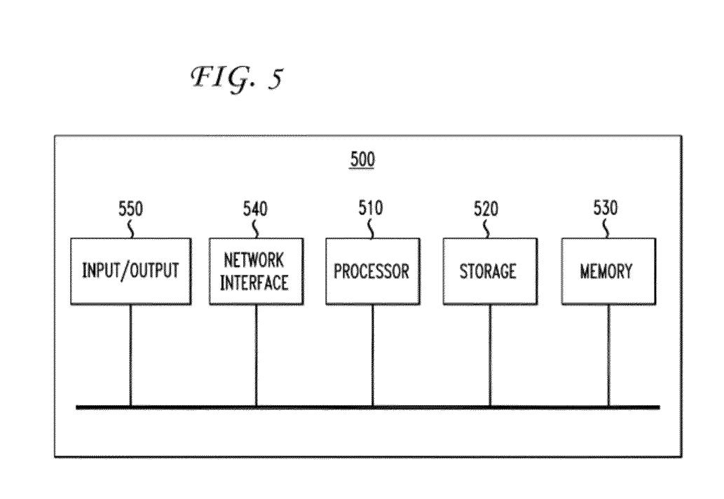

The above-described methods for generating an interface displaying a number of related messages can be implemented on a computer using well-known computer processors, memory units, storage devices, computer software, and other components. A high-level block diagram of such a computer is illustrated in FIG. 5. Computer 500 contains a processor 510 that controls the overall operation of the computer 500 by executing computer program instructions that define such operations. The computer program instructions may be stored in a storage device 520, or other computer readable medium (e.g., magnetic disk, CD ROM, etc.), and loaded into memory 530 when execution of the computer program instructions is desired. Thus, the method steps of FIG. 4 can be defined by the computer program instructions stored in the memory 530 and/or storage 520 and controlled by the processor 510 executing the computer program instructions. For example, the computer program instructions can be implemented as computer executable code programmed by one skilled in the art to perform an algorithm defined by the method steps of FIG. 4. Accordingly, by executing the computer program instructions, the processor 510 executes an algorithm defined by the method steps of FIG. 4. The computer 500 also includes one or more network interfaces 540 for communicating with other devices via a network. The computer 500 also includes input/output devices 550 that enable user interaction with the computer 500 (e.g., display, keyboard, mouse, speakers, buttons, etc.). One such input/output device 550 includes a display configured to present an interface as described above. One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the disclosure is not to be determined from the Detailed Description, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the disclosure. Those skilled in the art could implement various other feature combinations without departing from the scope and spirit of the disclosure. The various functional modules that are shown are for illustrative purposes only, and may be combined, rearranged and/or otherwise modified.

We claim:

1. A method of presenting a plurality of related electronic messages comprising:
associating each of the plurality of related electronic messages with a respective message generation;
displaying a first set of message nodes associated with a first message generation, each message node associated with one of the plurality of related electronic messages;
displaying a second set of message nodes associated with a second message generation, the second message generation being immediately subsequent to the first message generation, each message node of the second set of message nodes associated with a particular message node of the first set of message nodes, the association representing at least a portion of a respective message lineage

2. The method of claim 1, further comprising displaying an indication of the associations between each message node of the second set of message nodes and the respective message node of the first set of message nodes.

3. The method of claim 1, further comprising:
displaying a third set of message nodes associated with a third message generation, the third generation being immediately subsequent to the second message generation, and each message node of the third set of message nodes associated with a particular message node of the second set of message nodes, the association representing at least a portion of a respective message lineage.

4. The method of claim 1, further comprising filtering the plurality of electronic messages such that each message associated with the first and second set of message nodes includes a particular user as at least one of a sender and a recipient.

5. The method of claim 1, further comprising identifying all participants in the plurality of related electronic messages, wherein a participant comprises at least one of a sender and a recipient.

6. The method of claim 1, further comprising identifying all passive participants in the plurality of related electronic messages.

7. The method of claim 1, further comprising identifying a selected set of message nodes from the displayed message nodes based on a matching criteria.

8. A system for presenting a plurality of related electronic messages comprising:
means for associating each of the plurality of related electronic messages with a respective message generation;
means for displaying a first set of message nodes associated with a first message generation, each message node associated with one of the plurality of related electronic messages; and
means for displaying a second set of message nodes associated with a second message generation, the second message generation being immediately subsequent to the first message generation, each message node of the second set of message nodes associated with a particular message node of the first set of message nodes, the association representing at least a portion of a respective message lineage

9. The system of claim 9, further comprising means for displaying an indication of the associations between each message node of the second set of message nodes and the respective message node of the first set of message nodes.

10. The system of claim 9, further comprising means for displaying a third set of message nodes associated with a third message generation, the third generation being immediately subsequent to the second message generation, and each message node of the third set of message nodes associated with a particular message node of the second set of message nodes, the association representing at least a portion of a respective message lineage.

11. The system of claim 9, further comprising means for filtering the plurality of electronic messages such that each message associated with the first and second set of message nodes includes a particular user as at least one of a sender and a recipient.

12. The system of claim 9, further comprising means for identifying all participants in the plurality of related electronic messages, wherein a participant comprises at least one of a sender and a recipient.

13. The system of claim 9, further comprising means for identifying all passive participants in the plurality of related electronic messages.

14. The system of claim 9, further comprising means for identifying a selected set of message nodes from the displayed message nodes based on a matching criteria.

15. An article of manufacture including a computer-readable medium having instructions stored thereon, that, in response to execution by a computing device, cause the computing device to perform operations comprising:
associating each of the plurality of related electronic messages with a respective message generation;
displaying a first set of message nodes associated with a first message generation, each message node associated with one of the plurality of related electronic messages;
displaying a second set of message nodes associated with a second message generation, the second message generation being immediately subsequent to the first message generation, each message node of the second set of message nodes associated with a particular message node of the first set of message nodes, the association representing at least a portion of a respective message lineage

16. The article of manufacture of claim 15, wherein the operations further comprise:
displaying an indication of the associations between each message node of the second set of message nodes and the respective message node of the first set of message nodes.

17. The article of manufacture of claim 15, wherein the operations further comprise:
displaying a third set of message nodes associated with a third message generation, the third generation being immediately subsequent to the second message generation, and each message node of the third set of message nodes associated with a particular message node of the second set of message nodes, the association representing at least a portion of a respective message lineage.

18. The article of manufacture of claim 15, wherein the operations further comprise filtering the plurality of electronic messages such that each message associated with the first and second set of message nodes includes a particular user as at least one of a sender and a recipient.

19. The article of manufacture of claim 15, wherein the operations further comprise:
identifying all participants in the plurality of related electronic messages, wherein a participant comprises at least one of a sender and a recipient.

20. The article of manufacture of claim 15, wherein the operations further comprise:
identifying all passive participants in the plurality of related electronic messages.
